(19) United States
(12) Patent Application Publication
(10) Pub. No.: US 2022/0272592 A1
(43) Pub. Date: Aug. 25, 2022

(54) UE POSITIONING USING A SUBSTITUTE ANCHOR

(71) Applicant: QUALCOMM Incorporated, San Diego, CA (US)

(72) Inventors: Chang-Sik Choi, Seoul (KR); Kapil Gulati, Belle Mead, NJ (US); Junyi Li, Franklin Park, NJ (US)

(21) Appl. No.: 17/183,168

(22) Filed: Feb. 23, 2021

(51) Int. Cl. H04W 36/00

(52) U.S. Cl. CPC H04W 36/03; H04W 36/0009

(57) ABSTRACT

A wireless communication device includes: a transceiver; a memory; and a processor communicatively coupled to the transceiver and the memory and configured to: transmit, via the transceiver, a capability message indicating a capability of the wireless communication device to serve as a substitute anchor for positioning; and perform at least one substitute anchor operation for a positioning session with a target user equipment based on: (1) the target user equipment and an original anchor having a first non-line-of-sight relationship; and (2) the target user equipment and the wireless communication device having a first line-of-sight relationship.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example wireless communication device includes: a transceiver; a memory; and a processor communicatively coupled to the transceiver and the memory and configured to: transmit, via the transceiver, a capability message indicating a capability of the wireless communication device to serve as a substitute anchor for positioning; and perform at least one substitute anchor operation for a positioning session with a target user equipment based on: (1) the target user equipment and an original anchor having a first non-line-of-sight relationship; and (2) the target user equipment and the wireless communication device having a first line-of-sight relationship.

Implementations of such a wireless communication device may include one or more of the following features. To perform the at least one substitute anchor operation, the processor is configured to: transmit, via the transceiver to the target user equipment, a positioning reference signal (PRS) configuration message containing one or more PRS configuration parameters; and transmit, via the transceiver, a first PRS in accordance with the one or more PRS configuration parameters. The target user equipment is a first target user equipment, the positioning session is a first positioning session, and the at least one substitute anchor operation is at least one first substitute anchor operation, and the processor is configured to perform at least one second substitute anchor operation for a second positioning session overlapping in time with the first positioning session.

Also or alternatively, implementations of such a wireless communication device may include one or more of the following features. The processor is configured to inhibit performance of the at least one substitute anchor operation based on the target user equipment and the original anchor having changed from the first non-line-of-sight relationship to a second line-of-sight relationship. The processor is configured to, in response to (1) and (2), transmit an indication to the target user equipment not to use at least one of measurement of a second PRS sent from the original anchor or a measurement indication sent from the original anchor indicating measurement of a third PRS from the target user equipment. The processor is configured to determine repeatedly, in response to presence of (1) and lack of (2), whether the target user equipment and the wireless communication device have changed from a second non-line-of-sight relationship to the first line-of-sight relationship. The processor is configured to perform the at least one substitute anchor operation for the positioning session with the target user equipment based further on a location of the wireless communication device being obtained by the processor. The processor is configured to perform the at least one substitute anchor operation for the positioning session with the target user equipment based further on the wireless communication device and the original anchor having a third line-of-sight relationship. The processor is configured, in order to determine that the target user equipment and the original anchor have the first non-line-of-sight relationship, to at least one of: determine that the original anchor reported not receiving a first positioning reference signal from the target user equipment; or determine that the target user equipment reported not receiving a second positioning reference signal from the original anchor; or determine that a first distance between the target user equipment and the original anchor reported by the original anchor is different from a second distance between the target user equipment and the original anchor reported by the target user equipment. The processor is configured to transmit the capability message as a basic safety message.

Another example wireless communication device includes: means for transmitting a capability message indicating a capability of the wireless communication device to serve as a substitute anchor for positioning; and means for performing at least one substitute anchor operation for a positioning session with a target user equipment based on: (1) the target user equipment and an original anchor having a first non-line-of-sight relationship; and (2) the target user equipment and the wireless communication device having a first line-of-sight relationship.

Implementations of such a wireless communication device may include one or more of the following features. The means for performing the at least one substitute anchor operation include: means for transmitting, to the target user equipment, a positioning reference signal (PRS) configuration message containing one or more PRS configuration parameters; and means for transmitting a first PRS in accordance with the one or more PRS configuration parameters. The target user equipment is a first target user equipment, the positioning session is a first positioning session, and the means for performing the at least one substitute anchor operation include means for performing at least one first substitute anchor operation for the first positioning session and means for performing at least one second substitute anchor operation for a second positioning session overlapping in time with the first positioning session.

Also or alternatively, implementations of such a wireless communication device may include one or more of the following features. The wireless communication device includes means for inhibiting performance of the at least one substitute anchor operation based on the target user equipment and the original anchor having changed from the first non-line-of-sight relationship to a second line-of-sight relationship. The wireless communication device includes means for transmitting, in response to (1) and (2), an indication to the target user equipment not to use, to determine a location of the target user equipment, at least one of a measurement of a second PRS sent from the original anchor or a measurement indication sent from the original anchor indicating measurement of a third PRS from the target user equipment. The wireless communication device includes means for repeatedly determining, in response to presence of (1) and lack of (2), whether the target user equipment and the wireless communication device have changed from a second non-line-of-sight relationship to the first line-of-sight relationship. The means for performing the at least one substitute anchor operation are for performing the at least one substitute anchor operation based further on a location of the wireless communication device being obtained. The means for performing the at least one substitute anchor operation are for performing the at least one substitute anchor operation based further on the wireless communication device and the original anchor having a third line-of-sight relationship. The wireless communication device includes relationship-determining means for determining whether the target user equipment and the original anchor have the first non-line-of-sight relationship, the relationship-determining means comprising at least one of: means for determining whether the original anchor reported not receiving a first positioning reference signal from the target user equipment; or means for determining whether the target user equipment reported not receiving a second positioning reference signal from the original anchor; or means for determining that a first distance between the target user equipment and the original anchor reported by the original anchor is different from a second distance between the target user equipment and the original anchor reported by the target user equipment. The means for transmitting the capability message are for transmitting the capability message as a basic safety message.

An example method at a wireless communication device for providing a substitute anchor includes: transmitting a capability message indicating a capability of the wireless communication device to serve as a substitute anchor for positioning; and performing at least one substitute anchor operation for a positioning session with a target user equipment based on: (1) the target user equipment and an original anchor having a first non-line-of-sight relationship; and (2) the target user equipment and the wireless communication device having a first line-of-sight relationship.

Implementations of such a method may include one or more of the following features. Performing the at least one substitute anchor operation includes: transmitting, to the target user equipment, a positioning reference signal (PRS) configuration message containing one or more PRS configuration parameters; and transmitting a first PRS in accordance with the one or more PRS configuration parameters. The target user equipment is a first target user equipment, the positioning session is a first positioning session, and performing the at least one substitute anchor operation includes performing at least one first substitute anchor operation for the first positioning session and performing at least one second substitute anchor operation for a second positioning session overlapping in time with the first positioning session.

Also or alternatively, implementations of such a method may include one or more of the following features. The method includes inhibiting performance of the at least one substitute anchor operation based on the target user equipment and the original anchor having changed from the first non-line-of-sight relationship to a second line-of-sight relationship. The method includes transmitting, in response to (1) and (2), an indication to the target user equipment not to use, to determine a location of the target user equipment, at least one of a measurement of a second PRS sent from the original anchor or a measurement indication sent from the original anchor indicating measurement of a third PRS from the target user equipment. The method includes repeatedly determining, in response to presence of (1) and lack of (2), whether the target user equipment and the wireless communication device have changed from a second non-line-of-sight relationship to the first line-of-sight relationship. Performing the at least one substitute anchor operation includes performing the at least one substitute anchor operation based further on a location of the wireless communication device being obtained. Performing the at least one substitute anchor operation includes performing the at least one substitute anchor operation based further on the wireless communication device and the original anchor having a third line-of-sight relationship. The method includes determining whether the target user equipment and the original anchor have the first non-line-of-sight relationship by at least one of: determining whether the original anchor reported not receiving a first positioning reference signal from the target user equipment; or determining whether the target user equipment reported not receiving a second positioning reference signal from the original anchor; or determining that a first distance between the target user equipment and the original anchor reported by the original anchor is different from a second distance between the target user equipment and the original anchor reported by the target user equipment. Transmitting the capability message includes transmitting the capability message as a basic safety message.

An example non-transitory, processor-readable storage medium includes processor-readable instructions configured to cause a processor of a wireless communication device, in order for the wireless communication device to provide a substitute anchor, to: transmit a capability message indicating a capability of the wireless communication device to serve as the substitute anchor for positioning; and perform at least one substitute anchor operation for a positioning session with a target user equipment based on: (1) the target user equipment and an original anchor having a first non-line-of-sight relationship; and (2) the target user equipment and the wireless communication device having a first line-of-sight relationship.

Implementations of such a storage medium may include one or more of the following features. The processor-readable instructions configured to cause the processor to perform the at least one substitute anchor operation comprise processor-readable instructions configured to cause the processor to: transmit, to the target user equipment, a positioning reference signal (PRS) configuration message containing one or more PRS configuration parameters; and transmit a first PRS in accordance with the one or more PRS configuration parameters. The target user equipment is a first target user equipment, the positioning session is a first positioning session, and the processor-readable instructions configured to cause the processor to perform the at least one substitute anchor operation include processor-readable instructions configured to cause the processor to perform at least one first substitute anchor operation for the first positioning session, and wherein the storage medium further comprises processor-readable instructions configured to cause the processor to perform at least one second substitute anchor operation for a second positioning session overlapping in time with the first positioning session.

Also or alternatively, implementations of such a storage medium may include one or more of the following features. The storage medium includes processor-readable instructions configured to cause the processor to inhibit performance of the at least one substitute anchor operation based on the target user equipment and the original anchor having changed from the first non-line-of-sight relationship to a second line-of-sight relationship. The storage medium includes processor-readable instructions configured to cause the processor to transmit, in response to (1) and (2), an indication to the target user equipment not to use, to determine a location of the target user equipment, at least one of a measurement of a second PRS sent from the original anchor or a measurement indication sent from the original anchor indicating measurement of a third PRS from the target user equipment. The storage medium includes processor-readable instructions configured to cause the processor to determine repeatedly, in response to presence of (1) and lack of (2), whether the target user equipment and the wireless communication device have changed from a second non-line-of-sight relationship to the first line-of-sight relationship. The processor-readable instructions configured to cause the processor to perform the at least one substitute anchor operation include processor-readable instructions configured to cause the processor to perform the at least one substitute anchor operation based further on a location of the wireless communication device being obtained. The processor-readable instructions configured to cause the processor to perform the at least one substitute anchor operation include processor-readable instructions configured to cause the processor to perform the at least one substitute anchor operation based further on the wireless communication device and the original anchor having a third line-of-sight relationship. The storage medium includes processor-readable instructions configured to cause the processor, to determine whether the target user equipment and the original anchor have the first non-line-of-sight relationship, to at least one of: determine whether the original anchor reported not receiving a first positioning reference signal from the target user equipment; or determine whether the target user equipment reported not receiving a second positioning reference signal from the original anchor; or determine that a first distance between the target user equipment and the original anchor reported by the original anchor is different from a second distance between the target user equipment and the original anchor reported by the target user equipment. The processor-readable instructions configured to cause the processor to transmit the capability message include processor-readable instructions configured to cause the processor to transmit the capability message as a basic safety message.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIG. 5 is a simplified perspective view of a positioning system.

FIG. 6 is a block diagram of a user equipment.

FIG. 7 is a block diagram of an original anchor.

FIG. 8 is a block diagram of a substitute anchor.

FIG. 9 is a block diagram of a session controller.

FIG. 10 is a simplified flow diagram of a method of determining position information.

FIG. 11 is a processing and signal flow for determining position information.

FIG. 12 is a block flow diagram of a method for providing a substitute anchor.

### DETAILED DESCRIPTION

Techniques are discussed herein for using a device (e.g., a user equipment (UE), a roadside unit, etc.) as a substitute anchor for a positioning session with a target UE for determining a location of the target UE. The substitute anchor may assume the role of an original anchor of the positioning session with the target UE based on the original anchor and the target UE having a non-line-of-sight relationship, at least for positioning reference signals. The anchor may send and/or receive reference signals to and/or from the target UE for measurement and use in determining a location of the target UE. The anchor may send and/or receive reference signals to and/or from the original anchor for measurement and use in determining a location of the substitute anchor. The substitute anchor may send one or more capability messages (e.g., intermittently without prompting and/or in response to a request to be a substitute anchor point) indicating the capability of the device to serve as a substitute anchor point. The capability message(s) may provide further specifics as to the abilities of the substitute anchor, e.g., regarding types of signaling and/or positioning techniques supported by the substitute anchor. Other examples, however, may be implemented.

Items and/or techniques described herein may provide one or more of the following capabilities, as well as other capabilities not mentioned. Geometric constraints for positioning may be overcome, e.g., by providing spatial diversity. Positioning of a UE may be achieved despite a non-line-of-sight condition with respect to an anchor device, e.g., while conserving power relative to powering a device continuously to provide a backup anchor device, while reducing architecture complexity (e.g., by avoiding upper-layer coordination, e.g., from a core network, to provide a substitute anchor, and/or while reducing signaling overhead relative to an always-on device serving as an anchor device. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

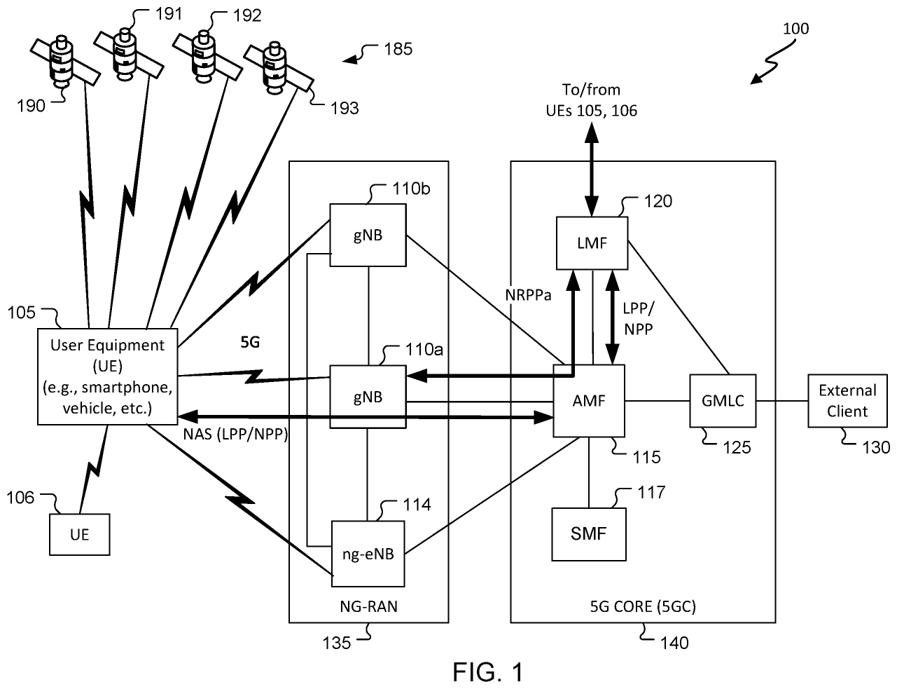

Referring to FIG. 1, an example of a communication system 100 includes a UE 105, a UE 106, a Radio Access Network (RAN) 135, here a Fifth Generation (5G) Next Generation (NG) RAN (NG-RAN), and a 5G Core Network (5GC) 140. The UE 105 and/or the UE 106 may be, e.g., an IoT device, a location tracker device, a cellular telephone, a vehicle, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. The BSs 110a, 110b, 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more of the BSs 110a, 110b, 114 may be configured to communicate with the UE 105 via multiple carriers. Each of the BSs 110a, 110b, 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the BSs 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples only as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the BSs 110a, 110b, 114, the core network 140, and/or the external client 130. For example, such other devices may include internet of thing (IoT) devices, medical devices, home entertainment and/or automation devices, etc. The core network 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the BSs 110a, 110b, 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the core network 140, and may provide QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though only one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-U IRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

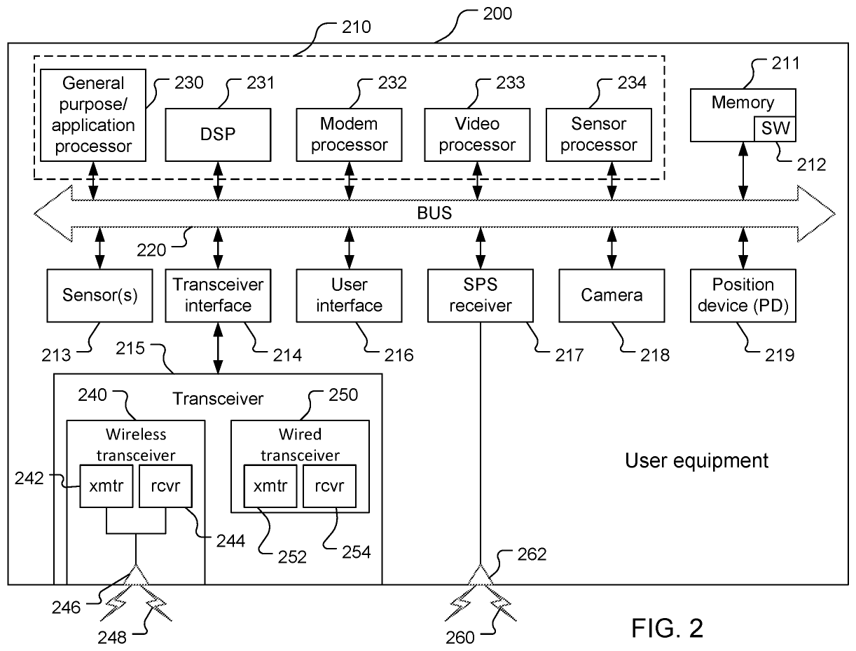

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250, a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more cellular wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., with the network 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer only to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general purpose/application processor 230, the transceiver 215, the SPS receiver 262, and/or another component of the UE 200, and may be provided by hardware, software, firmware, or various combinations thereof.

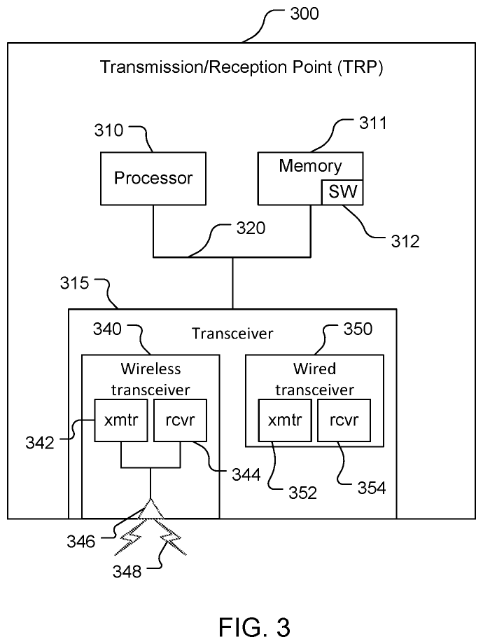

Referring also to FIG. 3, an example of a TRP 300 of the BSs 110a, 110b, 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer only to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the network 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

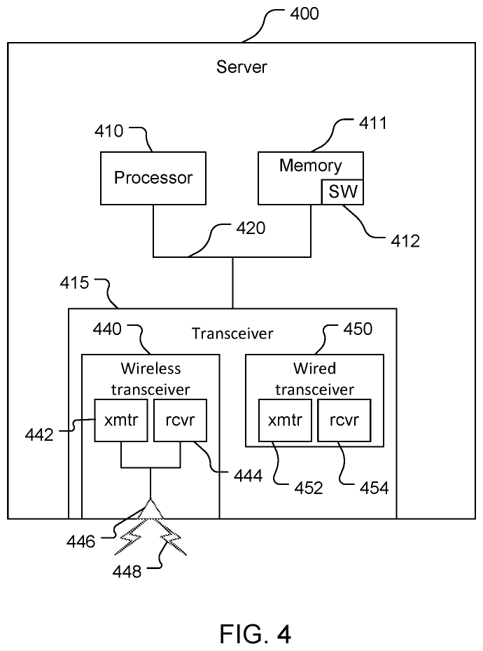

Referring also to FIG. 4, a server 400, which is an example of the LMF 120, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the network 135 to send communications to, and receive communications from, the TRP 300, for example, and/or one or more other entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer only to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that only the UEs subscribed to the service can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS), may refer to one reference signal or more than one reference signal.

Positioning reference signals (PRS) include downlink PRS (DL PRS) and uplink PRS (UL PRS) (which may be called SRS (Sounding Reference Signal) for positioning). PRS may comprise PRS resources or PRS resource sets of a frequency layer. A DL PRS positioning frequency layer (or simply a frequency layer) is a collection of DL PRS resource sets, from one or more TRPs, that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple Resource Elements (REs) that may be in multiple Resource Blocks (RBs) within N (one or more) consecutive symbol(s) within a slot. An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

UE-to-UE Positioning

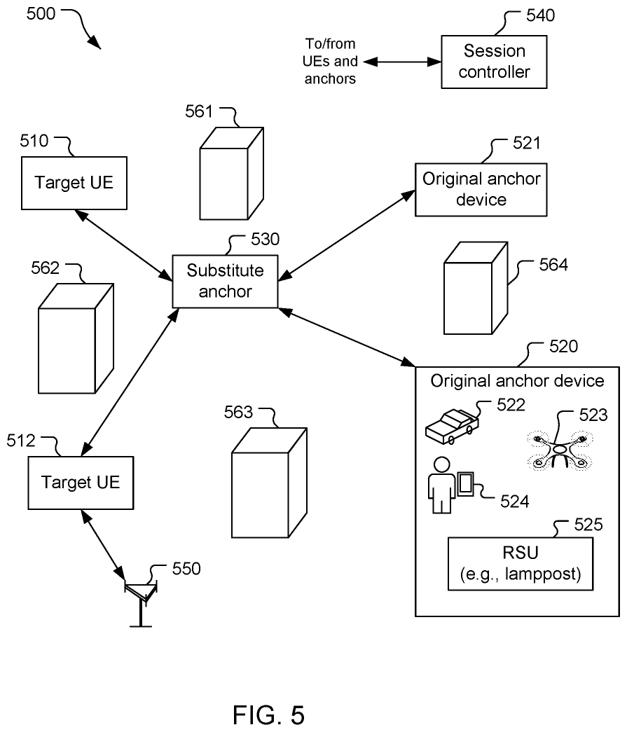

Referring to FIG. 5, with further reference to FIGS. 1-4, a positioning system 500 includes target UEs 510, 512, original anchor devices 520, 521, a substitute anchor device 530, a session controller 540, and a TRP 550 (e.g., a gNB), with the system 500 disposed among buildings 561, 562, 563, 564. An anchor device may also be called an anchor point or an anchor. The TRP 550 may be an example of the TRP 300, and more than one TRP may be included in the system 500 although only one TRP is shown in FIG. 5. Each of the UEs 510, 512 may be an example of the UE 200, and may take any of a variety of types. For example, each of the target UEs 510, 512 may be a smartphone, a vehicle, or a tablet computer, but other types of UEs may be used and the target UEs 510, 512 may be different types of UEs. Further, each of the original anchor devices 520, 521 may comprise any of a variety of types of devices. As shown, the original anchor device 520 is possibly a vehicle 522, an unoccupied aerial vehicle (UAV) 523 (e.g., a drone), a smartphone or tablet 524 of a pedestrian 525, or a roadside unit (RSU) 526 (e.g., incorporated into a lamppost), although other types of anchor devices may be used. The substitute anchor 530 may comprise any of a variety of types of devices. For example, the substitute anchor 530 may be a simple, low-complexity device, e.g., powered from outlet power and configured to provide little if any functionality beyond serving as an anchor for a positioning session. Due to mobility of the target UEs 510 and/or the anchor devices 520, 521, situations may occur where a line-of-sight (LOS) view between a target UE and an original anchor device is obstructed. In such situations, only non-line-of-sight (NLOS) paths may be available between the respective target UEs and the respective original anchor devices, but NLOS paths are undesirable for use in determining a location of a target UE. This may be particularly undesirable in situations where the target UE and the original anchor device are stationary for a significant amount of time. The target UEs 510, 512 may have insufficient anchor points for determining locations of the target UEs 510, 512, or determining the locations of the target UEs 510, 512 with desired accuracy. Consequently, it may be desirable to be able to use the substitute anchor device 530 as an anchor point with which to exchange one or more reference signals for determining the positions of the target UEs 510, 512, or for helping to determine the positions of the target UEs 510, 512 (e.g., to add to other measurements for determining the positions of the target UEs 510, 512). The substitute anchor device 530 may be used as a replacement for an obstructed original anchor device to provide one or more positioning functions to help with positioning of a target UE, e.g., exchanging of one or more positioning reference signals with the target UE(s) 510, 512, determining one or more measurements that may be used to determine, or at least help determine, locations of the target UEs 510, 512, etc. For example, the substitute anchor 530 may be configured to send and/or receive references signals to and/or from the target UEs 510, 512 to help determine positions of the target UEs 510, 512, e.g., by measuring reference signals from one or more of the target UEs 510, 512 and/or providing reference signals to the target UEs 510, 512 for measurement. The PRS signal exchange may be through sidelink (SL) communications. The exchange of PRS between the substitute anchor 530 and the target UEs 510, 512 may be in addition to an exchange of one or more PRS with another entity, e.g., the TRP 550. The substitute anchor 530 may provide an artificial LOS between the NLOS original anchor device(s) 521, 521 and the target UE(s) 510, 512 (e.g., to serve as an on-demand anchor for a positioning session). The substitute anchor 530 may be a UE, whether mobile or not. The substitute anchor 530 may be a simplified device, e.g., not having functionality that UEs often have such as cellular communication, photography, etc. The substitute anchor 530 may be configured to serve as a substitute anchor as discussed herein, with little if any additional functionality.

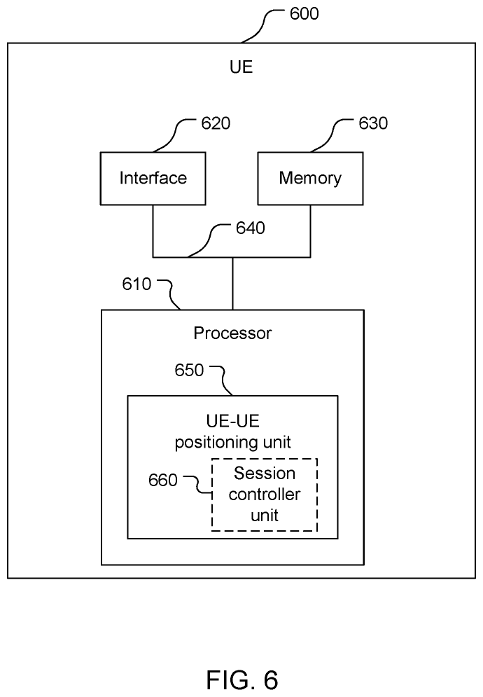

Referring to FIG. 6, with further reference to FIGS. 1-5, a target UE 600, and either of the target UEs 510, 512 shown in FIG. 5, includes a processor 610, an interface 620, and a memory 630 communicatively coupled to each other by a bus 640. The target UE 600 may any of a variety of types of UEs, e.g., a vehicle UE (V-UE), a pedestrian UE (P-UE), etc. The target UE 600 may include some or all of the components shown in FIG. 6, and may include one or more other components such as any of those shown in FIG. 2 such that the UE 200 may be an example of the UE 600. The processor 610 may include one or more components of the processor 210. The interface 620 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 620 may include the wired transmitter 252 and/or the wired receiver 254. The interface 620 may include the SPS receiver 217 and the antenna 262. The memory 630 may be configured similarly to the memory 211, e.g., including software with processor-readable instructions configured to cause the processor 610 to perform functions.

The description herein may refer only to the processor 610 performing a function, but this includes other implementations such as where the processor 610 executes software (stored in the memory 630) and/or firmware. The description herein may refer to the target UE 600 performing a function as shorthand for one or more appropriate components (e.g., the processor 610 and the memory 630) of the target UE 600 performing the function. The processor 610 (possibly in conjunction with the memory 630 and, as appropriate, the interface 620) includes UE-UE positioning unit 650. The UE-UE positioning unit 650 may be configured to exchange (e.g., send and/or receive) PRS with anchor devices (e.g., other UEs and/or other types of anchor devices), to measure PRS, and/or to determine position information (e.g., measurements, ranges, pseudoranges, and/or position estimates of the target UE 600) based on the PRS (e.g., received PRS and/or indications of position information determined from PRS sent by the target UE 600). The UE-UE positioning unit 650 may include a session controller unit 660 configured to, possibly among other things, determine whether a substitute anchor is desired and to request a substitute anchor if desired, and/or to determine whether a presently-used substitute anchor may be released from serving as a substitute anchor for the target UE 600. The configuration and functionality of the UE-UE positioning unit 650 is discussed further herein.

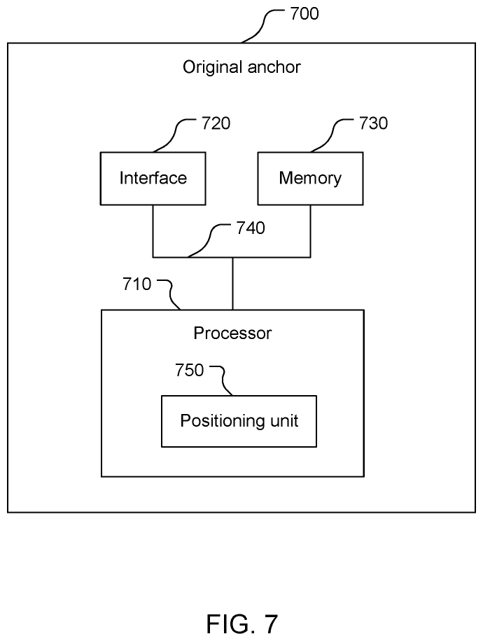

Referring to FIG. 7, with further reference to FIGS. 1-5, an original anchor 700, and/or either of the original anchor devices 520, 521 shown in FIG. 5, includes a processor 710, an interface 720, and a memory 730 communicatively coupled to each other by a bus 740. The original anchor 700 may include some or all of the components shown in FIG. 7, and may include one or more other components such as any of those shown in FIG. 2 such that the UE 200 may be an example of the original anchor 700. The processor 710 may include one or more components of the processor 210. The interface 720 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 720 may include the wired transmitter 252 and/or the wired receiver 254. The interface 720 may include the SPS receiver 217 and the antenna 262. The memory 730 may be configured similarly to the memory 211, e.g., including software with processor-readable instructions configured to cause the processor 710 to perform functions.

The description herein may refer only to the processor 710 performing a function, but this includes other implementations such as where the processor 710 executes software (stored in the memory 730) and/or firmware. The description herein may refer to the original anchor 700 performing a function as shorthand for one or more appropriate components (e.g., the processor 710 and the memory 730) of the original anchor 700 performing the function. The processor 710 (possibly in conjunction with the memory 730 and, as appropriate, the interface 720) includes positioning unit 750. The positioning unit 750 may be configured to exchange (e.g., send and/or receive) PRS with other devices (e.g., TRPs, UEs, and/or other anchor devices), to measure PRS, and/or to determine position information (e.g., measurements, ranges, pseudoranges, and/or position estimates of the original anchor 700 and/or other devices) based on the PRS (e.g., received PRS and/or indications of position information determined from PRS sent by the original anchor 700). The configuration and functionality of the positioning unit 750 is discussed further herein.

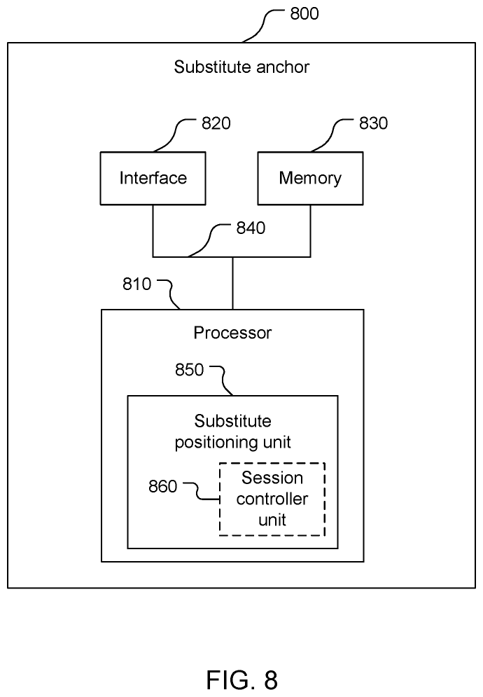

Referring to FIG. 8, with further reference to FIGS. 1-5, a substitute anchor 800, and/or the substitute anchor device 530 shown in FIG. 5, includes a processor 810, an interface 820, and a memory 830 communicatively coupled to each other by a bus 840. The substitute anchor 800 may include some or all of the components shown in FIG. 8, and may include one or more other components such as any of those shown in FIG. 2 such that the UE 200 may be an example of the substitute anchor 800. The processor 810 may include one or more components of the processor 210. The interface 820 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 820 may include the wired transmitter 252 and/or the wired receiver 254. The interface 820 may include the SPS receiver 217 and the antenna 262. The memory 830 may be configured similarly to the memory 211, e.g., including software with processor-readable instructions configured to cause the processor 810 to perform functions.

The description herein may refer only to the processor 810 performing a function, but this includes other implementations such as where the processor 810 executes software (stored in the memory 830) and/or firmware. The description herein may refer to the substitute anchor 800 performing a function as shorthand for one or more appropriate components (e.g., the processor 810 and the memory 830) of the substitute anchor 800 performing the function. The processor 810 (possibly in conjunction with the memory 830 and, as appropriate, the interface 820) includes a substitute positioning unit 850. The substitute positioning unit 850 may include a session controller unit 860 configured to determine whether to replace an original anchor for a positioning session with the target UE 600, e.g., whether to automatically join a positioning session, and/or whether to withdraw from a positioning session, etc. The substitute positioning unit 850 may be configured to exchange (e.g., send and/or receive) PRS with other devices (e.g., TRPs, UEs, and/or other anchor devices), to measure PRS, and/or to determine position information (e.g., measurements, ranges, pseudoranges, and/or position estimates of the substitute anchor 800 and/or other devices) based on the PRS (e.g., received PRS and/or indications of position information determined from PRS sent by the substitute anchor 800). The substitute positioning unit 850 may be configured to turn one or more anchor operations ON or OFF depending on a situation (e.g., depending on one or more factors indicating a desirability of the substitute anchor 800 to serve as a substitute anchor, e.g., providing one or more positioning functions). The substitute positioning unit 850 may be configured to turn one or more operations (e.g., sending pre-PRS and PRS, measuring PRS, etc.) off for a particular positioning session (e.g., a particular UE/anchor pair), and/or may be configured to turn operations off for all positioning sessions, The configuration and functionality of the substitute positioning unit 850 is discussed further herein.

The substitute positioning unit 850 may be configured to transmit a BSM (Basic Safety Message). The BSM may indicate a capability of the substitute anchor 800 to serve as a substitute anchor for a positioning session. The substitute positioning unit 850 may be configured to transmit the BSM in a licensed ITS (intelligent transportation system) spectrum and/or may be configured to transmit the BSM intermittently (e.g., aperiodically and/or periodically (at regular intervals)). The BSM may indicate that the substitute anchor 800 is capable of transmitting and/or receiving PRS, pre-PRS messages, and/or post-PRS messages. The BSM may include information regarding type and/or status of the substitute anchor 800, e.g., a vehicle type and/or speed of the substitute anchor 800.

The UE-UE positioning unit 650, the positioning unit 750, and the substitute positioning unit 850 may each be configured to encode, decode, and transmit respective PRS, pre-PRS messages, and/or post-PRS messages. The pre-PRS messages and the post-PRS messages may be transmitted in the ITS (licensed) spectrum and the PRS may be transmitted in an unlicensed spectrum. Each of the respective PRS may comprise a respective PN (pseudorandom noise) sequence identified by a corresponding identity (ID). The pre-PRS message may be transmitted in the ITS (licensed) spectrum, and may indicate one or more PRS configuration parameters (e.g., frequency layer, frequency offset, slot offset, comb number, etc.). The post-PRS message for each respective entity (i.e., the target UE 600, the original anchor 700, the substitute anchor 800) may be transmitted in the ITS (licensed) spectrum and/or may indicate one or more of a variety of information. For example, the post-PRS message may indicate which PRS the respective entity received, e.g., from which other entity PRS was/were received (regardless of whether the respective entity was involved in a position session involving the PRS), and may indicate a time of arrival (ToA) of each PRS received. The ToA in a post-PRS message corresponding to PRS that was not received may comprise a null (null values). As another example, the post-PRS message may indicate whether the pre-PRS-scheduled PRS of the respective entity was broadcast. As another example, the post-PRS message may indicate a time of departure of the respective PRS. As another example, the post-PRS message may indicate a location of the respective entity at the time of departure of the respective PRS. As another example, the post-PRS message may indicate a trajectory of the respective entity (e.g., may indicate a speed and direction, or may indicate information (e.g., a set of locations and times) from which the trajectory may be derived).

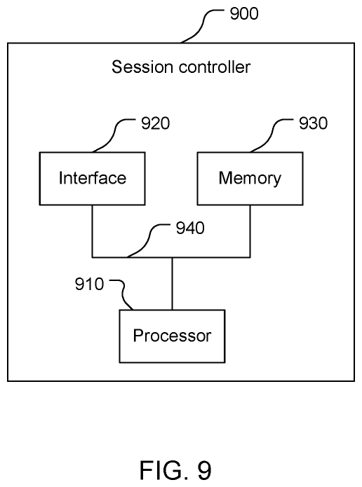

Referring to FIG. 9, with further reference to FIGS. 1-8, a session controller 900, and/or the session controller 540 shown in FIG. 5, includes a processor 910, an interface 920, and a memory 930 communicatively coupled to each other by a bus 940. The session controller 900 may include some or all of the components shown in FIG. 9, and may include one or more other components such as any of those shown in FIG. 2 or FIG. 4 such that the UE 200 may be an example of the session controller 900 and/or the server 400 may be an example of the session controller 900. The processor 910 may include one or more components of the processor 210 or the processor 410. The interface 920 may include one or more of the components of the transceiver 215 or the transceiver 415, e.g., the wireless transmitter 242, 442 and the antenna 246, 446 or the wireless receiver 244, 444 and the antenna 246, 446, or the wireless transmitter 242, 442, the wireless receiver 244, 444, and the antenna 246, 446. Also or alternatively, the interface 920 may include the wired transmitter 252, 452 and/or the wired receiver 254, 454. The interface 920 may include the SPS receiver 217 and the antenna 262. The memory 930 may be configured similarly to the memory 211, 411, e.g., including software with processor-readable instructions configured to cause the processor 910 to perform functions.

The description herein may refer only to the processor 910 performing a function, but this includes other implementations such as where the processor 910 executes software (stored in the memory 930) and/or firmware. The description herein may refer to the session controller 900 performing a function as shorthand for one or more appropriate components (e.g., the processor 910 and the memory 930) of the session controller 900 performing the function.

The session controller 900 may be separate from the target UE(s) and the anchor(s) as shown in FIG. 5, although the session controller 900 may be part of an entity such as a vehicle or roadside unit. Also or alternatively, functionality of the session controller 900, e.g., of the processor 910, may be contained in one or more other entities (e.g., completely in one or more entities or distributed among multiple entities). For example, functionality of the session controller 900 may be contained in the session controller unit 660 and/or the session controller unit 860. The description herein may refer to a function being performed by the session controller 900, the session controller unit 660, and/or the session controller unit 860, and this includes the function being performed by the session controller unit 660, the session controller unit 860, or the session controller 900 individually, or the function being performed by a combination of two or more of the session controller 900, the session controller unit 660, and/or the session controller unit 860. Thus, the processor 910 may be, for example, the processor 610 (e.g., the processor 210) or the processor 410, the interface 920 may be the interface 620 or the transceiver 415, and the memory 930 may be the memory 630 or the memory 411.

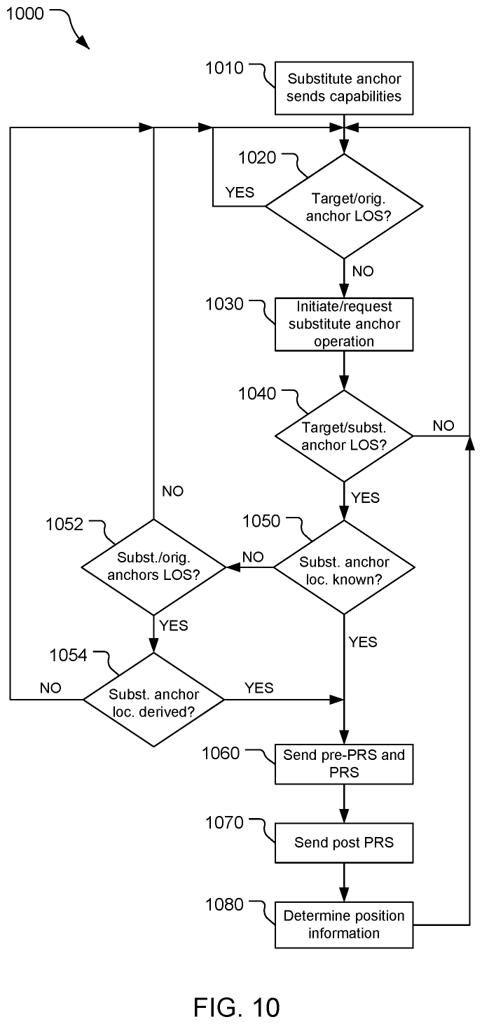

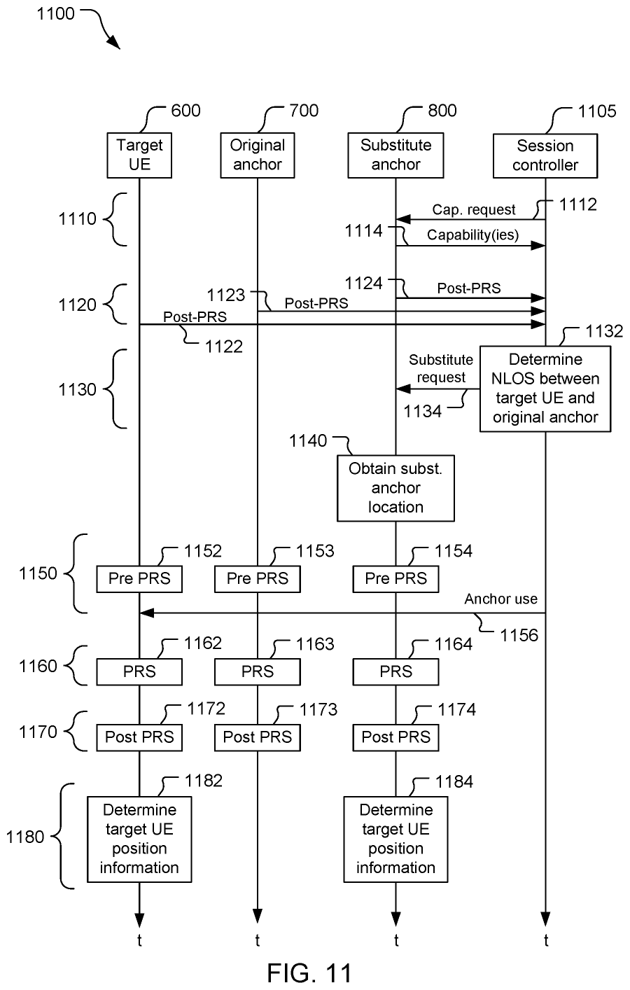

Referring also to FIGS. 10 and 11, a method 1000 of determining position information includes the stages shown and a processing and signal flow 1100 for determining position information includes the stages shown. The method 1000 and the flow 1100 are examples, and stages may be added to, removed from, and/or rearranged in the method 1000 and/or the flow 1100.

At stages 1010, 1110 the substitute anchor 800 sends an indication of substitute anchor capabilities, e.g., in a capability(ies) message 1114. The substitute anchor 800 may send the message 1114 in response to a capability request 1112 from the session controller 1105. The capability request 1112 may come from a device external to the substitute anchor 800 (via the interface 820) or may be an internal request, e.g., from the session controller unit 860 to another portion of the processor 810. The processor 810 may respond to the request 1112 by sending the message 1114, and/or may send the message 1114 independent of the request 1112 (e.g., periodically). For example, the substitute positioning unit 850 may be configured to send, via the interface 820 (e.g., the wireless transmitter 242 and the antenna 246), a BSM indicating the ability of the substitute anchor 800 to serve as a substitute anchor (e.g., the ability and availability to encode/decode and send/receive pre-PRS, PRS, and post-PRS). The substitute positioning unit 850 may be configured to broadcast the BSM for receipt by any entity within range, e.g., by the session controller 1105 as indicated by the capability(ies) message 1114. The substitute anchor 800 may not send the capability(ies) message 1114 in order to inhibit joining any ranging session, at least temporarily. The session controller 1105 as shown represents the session controller 900 as an entity separate from the target UE 600 and the original anchor 700, and/or as the session controller unit 660, and/or as the session controller unit 860. If the session controller 1105 is separate from the target UE 600 and the original anchor 700, the session controller 1105 may be a standalone entity or may be part of another entity such as a vehicle or roadside unit. Thus, the capability(ies) message 1114 may be received by one or more entities such as the session controller 900 and/or the target UE 600 (e.g., the session controller unit 660 of the target UE 600). The substitute anchor 800 may be configured to send the capability(ies) message 1114 repeatedly (e.g., periodically and/or on demand in response to a request) and to send the capability(ies) message 1114 at a different time than shown in FIG. 11 in addition to or instead of the time shown in FIG. 11. The flowchart in FIG. 10 shows the method 1000 returning to stage 1020, but stage 1010 may be performed repeatedly, e.g., during performance of other stages of the method 1000.

At stage 1020, an inquiry is made as to whether the target UE 600 and the original anchor 700 have an LOS relationship (i.e., are LOS or NLOS). For example, at stage 1120, the target UE 600, the original anchor 700, and the substitute anchor 800 may send post-PRS messages 1122, 1123, 1124 to the session controller 1105. The target UE 600 and the original anchor 700 may be configured to send the post-PRS messages 1122, 1123 containing information from which the session controller 1105 can determine, at sub-stage 1132 of stage 1130, whether the target UE 600 and the original anchor 700 are LOS. For example, the post-PRS messages 1122, 1123 may contain indications of distance between the target UE 600 and the original anchor 700 and/or one or more measurements from which the distance between the target UE 600 and the original anchor 700 can be determined. The session controller 1105 may monitor all post-PRS messages received, regardless of the positioning session, to determine an NLOS condition between a target UE and an anchor. The session controller 1105 may, for example, be configured to determine, at sub-stage 1132, whether the distance between the target UE 600 and the original anchor 700 indicated by the target UE 600 and the original anchor 700 are within a threshold difference, and determine that the target UE 600 and the original anchor 700 are LOS (i.e., have an LOS relationship) if so and NLOS (i.e., have an NLOS relationship) otherwise (e.g., if there is any difference or if difference is more than a threshold difference, e.g., more than 1% different). Also or alternatively, the session controller 1105 may, for example, be configured to determine, at sub-stage 1132, whether the post-PRS message 1122 indicates that PRS from the original anchor 700 was received by the target UE 600 and/or whether the post-PRS message 1123 indicates that PRS from the target UE 600 was received by the original anchor 700. If either (or both) of the target UE 600 or the original anchor 700 did not receive PRS from the other entity, then the session controller 1105 may conclude that the target UE 600 and the original anchor 700 are NLOS. Still other techniques may be used to determine whether the target UE 600 and the original anchor 700 are LOS or NLOS. The substitute anchor 800 may determine the NLOS relationship or LOS relationship of the target UE 600 and the original anchor 700, e.g., by receiving and analyzing the post-PRS messages 1122, 1123.

At stage 1030, substitute anchor operation of the substitute anchor 800 may be initiated or requested. For example, the session controller 1105 may be configured to determine whether a substitute anchor, e.g., the substitute anchor 800, is available and if so, to send, at sub-stage 1132, a substitute request message 1134 to the substitute anchor 800. If the session controller 1105 is physically separate from the substitute anchor 800, then the substitute request message 1134 may be sent via the interface 920 to the substitute anchor 800. If the session controller 1105 is part of the substitute anchor 800, e.g., the session controller unit 860, then the substitute request message 1134 may be sent to another portion of the substitute positioning unit 850. The session controller 1105 may be configured to initiate substitute operation, e.g., to turn ON processing by the substitute positioning unit to initiate scheduling of PRS from the substitute anchor 800 and prepare for sending of pre-PRS from the substitute anchor 800.

At stage 1040, an inquiry is made as to whether the target UE 600 and the substitute anchor 800 are LOS. For example, the session controller 1105 (e.g., the session controller unit 860) may be configured to determine (e.g., by analyzing the post-PRS message 1124) whether the substitute anchor 800 received PRS from the target UE 600, e.g., a most-recent PRS from the target UE 600 or PRS from the target UE 600 within a threshold amount of time from the present time. As another example, the substitute anchor 800 may be configured to send pre-PRS and PRS and analyze another post-PRS message 1122 from the target UE 600 and/or post-PRS information at the substitute anchor 800 (e.g., whether PRS from the target UE 600 was received, measurement of PRS from the target UE 600) to determine whether the target UE 600 and the substitute anchor 800 are LOS. For example, if either (or both) of the target UE 600 or the substitute anchor 800 did not receive PRS from the other entity, then the session controller 1105 may conclude that the target UE 600 and the substitute anchor 800 are NLOS. As another example, the session controller 1105 may be configured to determine whether distances between the target UE 600 and the substitute anchor 800 indicated in or determined from post-PRS information from the target UE 600 and the substitute anchor 800 are inconsistent (e.g., inequal or differ by more than a threshold amount). The session controller 1105 may be configured to conclude that the target UE 600 and the substitute anchor 800 are NLOS if the distances are inconsistent. If the session controller 1105 determines that the target UE 600 and the substitute anchor 800 are NLOS, then the method 1000 returns to stage 1020. If the session controller 1105 determines that the target UE 600 and the substitute anchor 800 are LOS, or at least does not determine that the target UE 600 and the substitute anchor 800 are NLOS, then the method 1000 returns to stage 1020.

At stage 1050, an inquiry is made as to whether a location of the substitute anchor 800 is known. For example, the location of the substitute anchor may be known from one or more techniques, e.g., from SPS measurements, from one or more cellular-based positioning techniques, etc. The location may be stored in and, at stage 1140, retrieved from the memory 830. If the location of the substitute anchor 800 is known, then the method 1000 proceeds to stage 1060, and otherwise proceeds to stage 1052.

At stage 1052, and inquiry is made as to whether the substitute anchor 800 and the original anchor 700 are LOS. For example, the session controller 1105 may be configured to determine from the post-PRS information of the substitute anchor 800 whether PRS from the original anchor 700 was received by the substitute anchor 800, e.g., the most-recent PRS from the original anchor 700 and/or PRS received within a threshold amount of time of the present time. The session controller 1105 may be configured to have the substitute anchor 800 send PRS and to analyze post-PRS information from the original anchor 700 to determine whether the anchors 700, 800 are LOS. Still other techniques may be used to determine LOS/NLOS status of the anchors 700, 800. If the session controller 1105 determines that the anchors 700, 800 are NLOS, then the method 1000 returns to stage 1020, and otherwise (if the session controller 1105 determines the anchors 700, 800 are LOS, or at least does not determine that the anchors 700, 800 are NLOS) proceeds to stage 1054.

At stage 1054, an inquiry is made as to whether the location of the substitute anchor 800 has been derived. For example, the session controller 1105 may be configured to attempt to determine, at stage 1140, the location of the substitute anchor 800 by exchanging multiple PRS with the original anchor 700. The PRS may be from the original anchor 700 and/or the substitute anchor 800 and exchanged over time while at least one of the anchors 700, 800 is moving. Multiple ranges between the anchors 700, 800 may be determined to find the location of the substitute anchor 800 relative to (with respect to) the original anchor 700. The relative location(s) may be used in combination with the location(s) (e.g., latitude(s) and longitude(s)) of the original anchor 700 to determine the location (e.g., latitude and longitude coordinates) of the substitute anchor 800. If the location of the substitute anchor 800 is not determined (e.g., with at least a threshold accuracy), then the method returns to stage 1020, and otherwise proceeds to stage 1060.

Returning to stage 1020 may help conserve power used by the substitute anchor 800. With the method 1000 returning to stage 1020 from stage 1040, 1052, or 1054, the substitute anchor 800 may avoid using processing effort and power to produce and send pre-PRS and PRS, e.g., in situations where doing so is unlikely to help the location of the target UE 600 be determined. This also reduces the signaling traffic and overhead compared to sending pre-PRS and PRS from the substitute anchor 800 regardless of the likely usefulness of sending such signals.

At stages 1060, 1150, 1160, one or more pre-PRS messages and one or more PRS are sent as the substitute anchor 800 serves as a substitute for the original anchor 700, e.g., takes over or replaces the original anchor 700 if the original anchor 700 previously exchanged PRS with the target UE 600 (although previous PRS exchange between the target UE 600 and the original anchor 700 is not required). For example, the UE-UE positioning unit 650 may be configured to send pre-PRS and PRS of the target UE 600 at sub-stages 1152, 1162, the positioning unit 750 may be configured to send pre-PRS and PRS of the original anchor 700 at sub-stages 1153, 1163, and the substitute positioning unit 850 may be configured to send pre-PRS and PRS of the substitute anchor 800 at sub-stages 1154, 1164. The pre-PRS may be broadcast, e.g., on an ITS licensed spectrum, and the PRS may be broadcast, e.g., on an unlicensed spectrum. The different spectra used for the pre-PRS and the PRS may permit configuration of a positioning session even if PRS may not be received. Also or alternatively, another entity (e.g., the server 400) may configure the positioning session. The pre-PRS of the target UE 600 may indicate that the substitute anchor 800 will be used in a positioning (ranging) session with the target UE 600. The PRS from the various entities may or may not be received by one or more of the other entities. The session controller 1105 may also send an anchor-use message 1156 to the target UE 600 indicating to the target UE 600. The anchor-use message 1156 may indicate not to use PRS and/or post-PRS information from the original anchor 700, e.g., to determine position information of the target UE 600, and/or that the PRS from the original anchor 700 is unreliable (e.g., NLOS, and thus multipath if received).

At stages 1070, 1170, one or more post-PRS messages are sent. For example, the UE-UE positioning unit 650 may be configured to send post-PRS of the target UE 600 at sub-stage 1172, the positioning unit 750 may be configured to send post-PRS of the original anchor 700 at sub-stage 1173, and the substitute positioning unit 850 may be configured to send post-PRS of the substitute anchor 800 at sub-stage 1174. The post-PRS messages may include information regarding all PRS received and may be broadcast, e.g., on an ITS licensed spectrum. The post-PRS messages may indicate whether various PRS were received at respective entities, measurements of the PRS, ToA of received PRS, ToD of sent PRS, location of the sending entity, trajectory of the sending entity, etc. A post-PRS message may indicate that one or more particular PRS were not received, e.g., based on the one or more particular PRS being scheduled to be sent, but the one or more particular PRS not being received by the respective entity sending the post-PRS message.

At stages 1080, 1180, position information for the target UE 600 is determined. For example, the UE-UE positioning unit 650 of the target UE 600 may be configured to use information from one or more of the post-PRS messages to determine, at sub-stage 1182, the location of the target UE 600. Also or alternatively, the substitute positioning unit 850 of the substitute anchor 800 may be configured to use information from one or more of the post-PRS messages to determine, at sub-stage 1184, the location of the target UE 600. The position information may include the location of the target UE 600 and/or information (e.g., one or more measurements) that may be used to determine the location of the target UE 600. Use of the substitute anchor 800 while the original anchor 700 is NLOS provides spatial richness not providable by the original anchor 700. Not using the substitute anchor 800 while the original anchor 700 is LOS helps reduce intervention overhead (e.g., signaling overhead, power consumption, etc.).

The method 1000 proceeds from stage 1080 by returning to stage 1020. The information from the post-PRS messages may be used for further instances of stages of the method 1000. For example, the post-PRS information may be used to determine, at stage 1020, whether the original anchor 700 and the target UE 600 are LOS, and/or to determine, at stage 1040, whether the target UE 600 and the substitute anchor 800 are LOS, and/or to determine, at stage 1052, whether the anchors 700, 800 are LOS.

The method 1000 may return to stage 1020 at any time that a request is received by the substitute anchor 800 not to serve as, or to stop serving as, a substitute anchor. The request may be received from the session controller 1105, e.g., in response to the session controller 1105 determining that the target UE 600 and the original anchor are LOS, e.g., change from NLOS to LOS.

By returning to stage 1020, the method 1000 will determine in an on-going manner whether the substitute anchor 800 should (begin or continue to) serve as a substitute anchor 800 for a position session (exchange of PRS) with the target UE 600. The ability of the substitute anchor 800 and/or the original anchor 700 to serve as an anchor (e.g., providing or receiving LOS PRS) for the target UE 600 may change over time (e.g., as the target UE 600 and/or the original anchor 700 and/or the substitute anchor 800 move). For example, if the target UE 600 and the original anchor 700 continue to be NLOS (e.g., as indicated by or determined from post-PRS information), then the substitute anchor 800 may continue to serve as a substitute anchor, e.g., if the substitute anchor 800 and the target UE 600 are LOS and the location of the substitute anchor 800 is known (e.g., determined). Also, by returning to stage 1020, the method 1000 may determine whether the original anchor 700, having been substituted for, should join (or rejoin) the position session with the target UE 600 such that the target UE 600 will use PRS from the original anchor 700 to determine position information for the target UE 600. For example, if a relationship between the target UE 600 and the original anchor 700 changes from NLOS to LOS (e.g., as indicated by or determined from post-PRS information), then the original anchor 700 may join or rejoin (as the case may be) the positioning session with the target UE 600 and the substitute anchor 800 may leave the positioning session (e.g., stop sending pre-PRS and PRS and/or processing PRS and/or post-PRS received from or regarding the target UE 600). In this case, the target UE 600 (and/or other entity) may use measurement(s) of PRS from the original anchor 700 by the target UE 600 for determining position information for the target UE 600.

The method 1000 may provide substitute anchor service while limiting architecture complexity. For example, by coordinating substitute anchor service at the target UE 600 and/or the substitute anchor 800 and/or another entity outside of the core network 140, upper-layer signaling and corresponding architecture complexity may be avoided.

The method 1000 may provide substitute anchor service as needed. The substitute anchor 800 may serve as an anchor in response to the target UE 600 and the original anchor 700 being NLOS, the target UE 600 and the substitute anchor 800 being LOS and the location of the substitute anchor 800 being known (e.g., determined). The substitute anchor 800 may not serve, or may stop serving, as an anchor in response to the target UE 600 and the original anchor 700 becoming LOS, the target UE 600 and the substitute anchor 800 being or becoming NLOS, or the location of the substitute anchor 800 being unknown. This may help provide spatial richness while avoiding wasted power consumption, e.g., by not sending PRS from the substitute anchor 800 regardless of need. The original anchor 700 may not be used while the original anchor 700 is NLOS with the target UE 600.

While the discussion of FIGS. 10 and 11 used an example of the substitute anchor 800 serving as an anchor for a single ranging session with the target UE 600, the substitute anchor 800 may be configured to serve as an anchor for multiple ranging sessions concurrently. For example, the substitute anchor 800 may concurrently serve as an anchor for the target UEs 510, 512 shown in FIG. 5, e.g., with the substitute anchor 800 configured to sense, decode, and/or encode multiple PRS overlapping in time.

### Operation

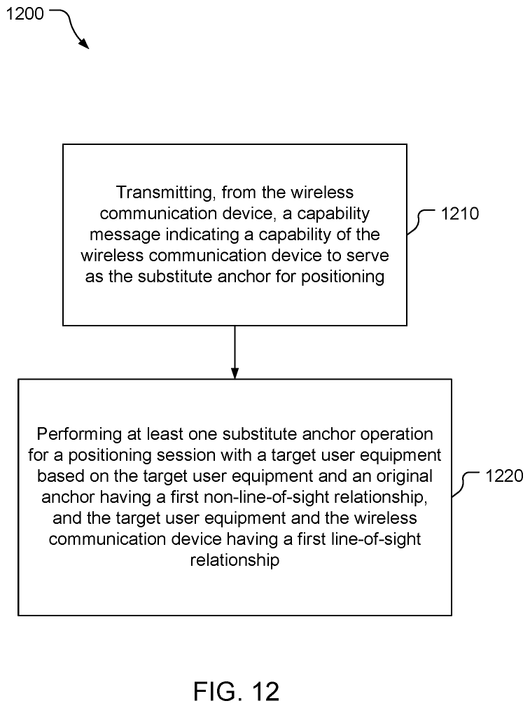

Referring to FIG. 12, with further reference to FIGS. 1-11, a method 1200 for providing a substitute anchor includes the stages shown. The method 1200 is, however, an example only and not limiting. The method 1200 may be altered, e.g., by having stages added, removed, rearranged, combined, performed concurrently, and/or having single stages split into multiple stages.

At stage 1210, the method 1200 includes transmitting, from the wireless communication device, a capability message indicating a capability of the wireless communication device to serve as the substitute anchor for positioning. For example, the substitute anchor 800 may send the capability(ies) message 1114 to the session controller 1105. The processor 810, possibly in combination with the memory 830, in combination with the interface 820 (e.g., the wireless transmitter 242 and the antenna 246) may comprise means for transmitting the capability message.

At stage 1220, the method 1200 includes performing at least one substitute anchor operation for a positioning session with a target user equipment based on: (1) the target user equipment and an original anchor having a first non-line-of-sight relationship; and (2) the target user equipment and the wireless communication device having a first line-of-sight relationship. For example, the substitute anchor 800 may serve as a substitute anchor if the target UE 600 and the original anchor 700 are NLOS and the target UE 600 and the substitute anchor 800 are LOS. The NLOS relationship of the target UE 800 and the original anchor 700 may be determined by the substitute anchor 800 by the processor 810 receiving and analyzing the post-PRS messages 1122, 1123, e.g., as discussed for the session controller 1105 with respect to stage 1132. Also or alternatively, the NLOS relationship of the target UE 800 and the original anchor 700 may be determined by the substitute anchor 800 by the processor 810 reading a message indicating the NLOS relationship or by the processor 810 reading a request (e.g., the substitute request 1134) to serve as a substitute anchor (thus implying the NLOS relationship). The processor 810, possibly in combination with the memory 830, possibly in combination with the interface 820 (e.g., the wireless transmitter 242 and the antenna 246, and/or the wireless receiver 244 and the antenna 246) may comprise means for performing at least one substitute anchor operation.

Implementations of the method 1200 may include one or more of the following features. In an example implementation, performing the at least one substitute anchor operation comprises: transmitting, to the target user equipment, a positioning reference signal (PRS) configuration message containing one or more PRS configuration parameters; and transmitting a first PRS in accordance with the one or more PRS configuration parameters. The processor 810, possibly in combination with the memory 830, in combination with the interface 820 (e.g., the wireless transmitter 242 and the antenna 246) may comprise means for sending the PRS configuration message and means for sending the PRS. In another example implementation, the target user equipment is a first target user equipment, the positioning session is a first positioning session, performing the at least one substitute anchor operation comprising performing at least one first substitute anchor operation for the first positioning session and performing at least one second substitute anchor operation for a second positioning session overlapping in time with the first positioning session. For example, the substitute anchor 800 may serve as a substitute anchor for multiple positioning sessions concurrently, e.g., for the target UEs 510, 512 shown in FIG. 5.

Also or alternatively, implementations of the method 1200 may include one or more of the following features. In an example implementation, the method 1200 includes inhibiting performance of the at least one substitute anchor operation based on the target user equipment and the original anchor having changed from the first non-line-of-sight relationship to a second line-of-sight relationship. The substitute anchor 800 may stop serving as a substitute anchor, e.g., turning OFF functions of sending pre-PRS and/or PRS, if the target UE 600 and the original anchor 700 become LOS. The change from an NLOS relationship to an LOS relationship may be determined by the substitute anchor 800, e.g., by the processor 810 analyzing appropriate signals, or receiving a message indicating the relationship change, or receiving a request, e.g., from the session controller 1105, to stop serving as a substitute anchor (e.g., for a particular positioning session). The processor 810, possibly in combination with the memory 830, may comprise means for inhibiting performance of the at least one substitute anchor operation. In another example implementation, the method 1200 includes transmitting, in response to (1) and (2), an indication to the target user equipment not to use, to determine a location of the target user equipment, at least one of a measurement of a second PRS sent from the original anchor or a measurement indication sent from the original anchor indicating measurement of a third PRS from the target user equipment. For example, based on the substitute anchor 800 serving as a substitute anchor and/or determining that the target UE 600 and the original anchor 700 are NLOS and the substitute anchor 800 and the target UE 600 are LOS, the substitute anchor 800 may transmit a message to the target UE 600 to indicate for the target UE 600 not to determine a location of the target UE 600 based on PRS or post-PRS information from the original anchor 700. The processor 810, possibly in combination with the memory 830, in combination with the interface 820 (e.g., the wireless transmitter 242 and the antenna 246) may comprise means for transmitting an indication to the target UE not to use a PRS measurement and/or a measurement indication from the original anchor to determine location of the target UE. In another example implementation, the method 1200 includes repeatedly determining, in response to presence of (1) and lack of (2), whether the target user equipment and the wireless communication device have changed from a second non-line-of-sight relationship to the first line-of-sight relationship. For example, if the target UE 600 and the original anchor 700 are determined to be NLOS or the substitute request 1134 is received (without receipt of a contradictory request to stop serving as a substitute anchor) but the target UE 600 and the substitute anchor 800 are NLOS, the session controller 1105 (e.g., the session controller unit 860) may repeatedly check whether the target UE 600 and the substitute anchor 800 are now LOS. If the target UE 600 and the substitute anchor 800 become LOS, with the target UE 600 and the original anchor 700 NLOS and/or the substitute request 1134 having been received and not contradicted, then the substitute anchor 800 may serve as a substitute anchor for the target UE 600. The processor 810, possibly in combination with the memory 830, in combination with the interface 820 (e.g., the wireless transmitter 242 and the antenna 246, and/or the wireless receiver 244 and the antenna 246) may comprise means for repeatedly determining whether the target user equipment and the wireless communication device have changed from NLOS to LOS.

Also or alternatively, implementations of the method 1200 may include one or more of the following features. In an example implementation, performing the at least one substitute anchor operation may be based further on a location of the wireless communication device being obtained. For example, the substitute anchor 800 serving as a substitute anchor (e.g., sending pre-PRS and PRS) may be conditioned on (only occur if) the location of the substitute anchor 800 is obtained (e.g., retrieved from memory, determined from SPS signals, determined from ranging (using PRS exchange) with the original anchor 700, etc.). The processor 810, possibly in combination with the memory 830, possibly in combination with the interface 820 (e.g., the wireless transmitter 242 and the antenna 246, and/or the wireless receiver 244 and the antenna 246, and/or the SPS receiver 217 and the antenna 262) may comprise means for obtaining the location of the substitute anchor. In another example implementation, performing the at least one substitute anchor operation may be based further on the wireless communication device and the original anchor having a third line-of-sight relationship. For example, the substitute anchor 800 serving as a substitute anchor (e.g., sending pre-PRS and PRS) may be conditioned on (only occur if) the substitute anchor 800 and the original anchor 700 being LOS. The LOS relationship of the substitute anchor 800 and the original anchor 700 may be determined by the substitute anchor 800 by signal analysis, by receiving a message indicating the LOS relationship, or by receiving a request, e.g., the request 1134 from the session controller 1105, to serve as a substitute anchor (thus implying the LOS relationship).

Also or alternatively, implementations of the method 1200 may include one or more of the following features. In an example implementation, the method 1200 includes determining whether the target user equipment and the original anchor have the first non-line-of-sight relationship by at least one of: determining whether the original anchor reported not receiving a first positioning reference signal from the target user equipment; or determining whether the target user equipment reported not receiving a second positioning reference signal from the original anchor; or determining that a first distance between the target user equipment and the original anchor reported by the original anchor is different from a second distance between the target user equipment and the original anchor reported by the target user equipment. For example, the original anchor 700 may explicitly report the distance between the target UE 600 and the original anchor 700 or implicitly report this distance, e.g., by reporting a measurement, such as RTT, that may be used to determine the distance. The NLOS condition may be determined by the post-PRS of the target UE 600 indicating that the PRS from the original anchor 700 was not received and/or the post-PRS from the original anchor 700 indicating that the PRS from the target UE 600 was not received. The indication may be explicit or implicit, e.g., not reporting a PRS measurement for the PRS. The NLOS condition may also or alternatively be determined by determining that the post-PRS explicitly or implicitly indicate distances between the target UE 600 and the original anchor 700 that do not agree (e.g., differ or differ by more than a threshold amount). The processor 810, possibly in combination with the memory 830, in combination with the interface 820 (e.g., the wireless receiver 244 and the antenna 246) may comprise means for determining whether the target user equipment and the original anchor are NLOS. In another example implementation, the capability message is a basic safety message.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, the term RS (reference signal) may refer to one or more reference signals and may apply, as appropriate, to any form of the term RS, e.g., PRS, SRS, CSI-RS, etc.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A wireless communication device comprising:
a transceiver;
a memory; and
a processor communicatively coupled to the transceiver and the memory and configured to:
transmit, via the transceiver, a capability message indicating a capability of the wireless communication device to serve as a substitute anchor for positioning; and
perform at least one substitute anchor operation for a positioning session with a target user equipment based on: (1) the target user equipment and an original anchor having a first non-line-of-sight relationship; and (2) the target user equipment and the wireless communication device having a first line-of-sight relationship.

2. The wireless communication device of claim 1, wherein to perform the at least one substitute anchor operation, the processor is configured to:
transmit, via the transceiver to the target user equipment, a positioning reference signal (PRS) configuration message containing one or more PRS configuration parameters; and
transmit, via the transceiver, a first PRS in accordance with the one or more PRS configuration parameters.

3. The wireless communication device of claim 2, wherein the target user equipment is a first target user equipment, the positioning session is a first positioning session, and the at least one substitute anchor operation is at least one first substitute anchor operation, and wherein the processor is configured to perform at least one second substitute anchor operation for a second positioning session overlapping in time with the first positioning session.

4. The wireless communication device of claim 1, wherein the processor is configured to inhibit performance of the at least one substitute anchor operation based on the target user equipment and the original anchor having changed from the first non-line-of-sight relationship to a second line-of-sight relationship.

5. The wireless communication device of claim 1, wherein the processor is configured to, in response to (1) and (2), transmit an indication to the target user equipment not to use at least one of measurement of a second PRS sent from the original anchor or a measurement indication sent from the original anchor indicating measurement of a third PRS from the target user equipment.

6. The wireless communication device of claim 1, wherein the processor is configured to determine repeatedly, in response to presence of (1) and lack of (2), whether the target user equipment and the wireless communication device have changed from a second non-line-of-sight relationship to the first line-of-sight relationship.

7. The wireless communication device of claim 1, wherein the processor is configured to perform the at least one substitute anchor operation for the positioning session with the target user equipment based further on a location of the wireless communication device being obtained by the processor.

8. The wireless communication device of claim 1, wherein the processor is configured to perform the at least one substitute anchor operation for the positioning session with the target user equipment based further on the wireless communication device and the original anchor having a third line-of-sight relationship.

9. The wireless communication device of claim 1, wherein the processor is configured, in order to determine that the target user equipment and the original anchor have the first non-line-of-sight relationship, to at least one of:
determine that the original anchor reported not receiving a first positioning reference signal from the target user equipment; or
determine that the target user equipment reported not receiving a second positioning reference signal from the original anchor; or
determine that a first distance between the target user equipment and the original anchor reported by the original anchor is different from a second distance between the target user equipment and the original anchor reported by the target user equipment.

10. The wireless communication device of claim 1, wherein the processor is configured to transmit the capability message as a basic safety message.

11. A wireless communication device comprising:
means for transmitting a capability message indicating a capability of the wireless communication device to serve as a substitute anchor for positioning; and
means for performing at least one substitute anchor operation for a positioning session with a target user equipment based on: (1) the target user equipment and an original anchor having a first non-line-of-sight relationship; and (2) the target user equipment and the wireless communication device having a first line-of-sight relationship.

12. The wireless communication device of claim 11, wherein the means for performing the at least one substitute anchor operation comprise:
means for transmitting, to the target user equipment, a positioning reference signal (PRS) configuration message containing one or more PRS configuration parameters; and
means for transmitting a first PRS in accordance with the one or more PRS configuration parameters.

13. The wireless communication device of claim 12, wherein the target user equipment is a first target user equipment, the positioning session is a first positioning session, and the means for performing the at least one substitute anchor operation comprise means for performing at least one first substitute anchor operation for the first positioning session and means for performing at least one second substitute anchor operation for a second positioning session overlapping in time with the first positioning session.

14. The wireless communication device of claim 11, further comprising means for inhibiting performance of the at least one substitute anchor operation based on the target user equipment and the original anchor having changed from the first non-line-of-sight relationship to a second line-of-sight relationship.

15. The wireless communication device of claim 11, further comprising means for transmitting, in response to (1) and (2), an indication to the target user equipment not to use, to determine a location of the target user equipment, at least one of a measurement of a second PRS sent from the original anchor or a measurement indication sent from the original anchor indicating measurement of a third PRS from the target user equipment.

16. The wireless communication device of claim 11, further comprising means for repeatedly determining, in response to presence of (1) and lack of (2), whether the target user equipment and the wireless communication device have changed from a second non-line-of-sight relationship to the first line-of-sight relationship.

17. The wireless communication device of claim 11, wherein the means for performing the at least one substitute anchor operation are for performing the at least one substitute anchor operation based further on a location of the wireless communication device being obtained.

18. The wireless communication device of claim 11, wherein the means for performing the at least one substitute anchor operation are for performing the at least one substitute anchor operation based further on the wireless communication device and the original anchor having a third line-of-sight relationship.

19. The wireless communication device of claim 11, further comprising relationship-determining means for determining whether the target user equipment and the original anchor have the first non-line-of-sight relationship, the relationship-determining means comprising at least one of:
means for determining whether the original anchor reported not receiving a first positioning reference signal from the target user equipment; or
means for determining whether the target user equipment reported not receiving a second positioning reference signal from the original anchor; or
means for determining that a first distance between the target user equipment and the original anchor reported by the original anchor is different from a second distance between the target user equipment and the original anchor reported by the target user equipment.

20. The wireless communication device of claim 11, wherein the means for transmitting the capability message are for transmitting the capability message as a basic safety message.

21. A method at a wireless communication device for providing a substitute anchor, the method comprising:
transmitting a capability message indicating a capability of the wireless communication device to serve as a substitute anchor for positioning; and
performing at least one substitute anchor operation for a positioning session with a target user equipment based on: (1) the target user equipment and an original anchor having a first non-line-of-sight relationship; and (2) the target user equipment and the wireless communication device having a first line-of-sight relationship.

22. The method of claim 21, wherein performing the at least one substitute anchor operation comprises:
transmitting, to the target user equipment, a positioning reference signal (PRS) configuration message containing one or more PRS configuration parameters; and
transmitting a first PRS in accordance with the one or more PRS configuration parameters.

23. The method of claim 22, wherein the target user equipment is a first target user equipment, the positioning session is a first positioning session, and performing the at least one substitute anchor operation comprises performing at least one first substitute anchor operation for the first positioning session and performing at least one second substitute anchor operation for a second positioning session overlapping in time with the first positioning session.

24. A non-transitory, processor-readable storage medium comprising processor-readable instructions configured to cause a processor of a wireless communication device, in order for the wireless communication device to provide a substitute anchor, to:
transmit a capability message indicating a capability of the wireless communication device to serve as the substitute anchor for positioning; and
perform at least one substitute anchor operation for a positioning session with a target user equipment based on: (1) the target user equipment and an original anchor having a first non-line-of-sight relationship; and (2) the target user equipment and the wireless communication device having a first line-of-sight relationship.

25. The storage medium of claim 24, wherein the processor-readable instructions configured to cause the processor to perform the at least one substitute anchor operation comprise processor-readable instructions configured to cause the processor to:
transmit, to the target user equipment, a positioning reference signal (PRS) configuration message containing one or more PRS configuration parameters; and
transmit a first PRS in accordance with the one or more PRS configuration parameters.

26. The storage medium of claim 25, wherein the target user equipment is a first target user equipment, the positioning session is a first positioning session, and the processor-readable instructions configured to cause the processor to perform the at least one substitute anchor operation comprise processor-readable instructions configured to cause the processor to perform at least one first substitute anchor operation for the first positioning session, and wherein the storage medium further comprises processor-readable instructions configured to cause the processor to perform at least one second substitute anchor operation for a second positioning session overlapping in time with the first positioning session.
